(19) United States
(12) Patent Application Publication
(10) Pub. No.: US 2014/0281000 A1
(43) Pub. Date: Sep. 18, 2014

(54) SCHEDULER BASED NETWORK VIRTUAL PLAYER FOR ADAPTIVE BIT RATE VIDEO PLAYBACK

(71) Applicants: Siddhartha Dattagupta, Irvine, CA (US); Mark Enright, Soquel, CA (US); Bich Tu Nguyen, Los Altos, CA (US)

(72) Inventors: Siddhartha Dattagupta, Irvine, CA (US); Mark Enright, Soquel, CA (US); Bich Tu Nguyen, Los Altos, CA (US)

(73) Assignee: CISCO TECHNOLOGY, INC., San Jose, CA (US)

(21) Appl. No.: 13/802,952

(22) Filed: Mar. 14, 2013

(51) Int. Cl. H04L 29/06

(52) U.S. Cl. CPC H04L 65/60
USPC 709/231

(57) ABSTRACT

A method is provided in one example embodiment and includes identifying a bit rate associated with an adaptive streaming client that is engaged in a media session, where the bit rate is used to maintain a particular video quality for a media stream. The method also includes using a network virtual player to lock the bit rate for a particular time interval for the adaptive streaming client; and supporting the bit rate from a network for the adaptive streaming client during the media session. In more particular embodiments, the method can include detecting a plurality of congestion points flow instrumentation; and reducing a committed service rate for the virtual player based, at least in part, on the flow instrumentation.

### TECHNICAL FIELD

This disclosure relates in general to the field of communications and, more particularly, to a system and a method for providing a scheduler based network virtual player in adaptive streaming environments.

### BACKGROUND

End users have more media and communications choices than ever before. A number of prominent technological trends are currently afoot (e.g., more computing devices, more online video services, more Internet video traffic), and these trends are changing the media delivery landscape. Separately, these trends are pushing the limits of capacity and, further, degrading the performance of video, where such degradation creates frustration amongst end users, content providers, and service providers. In many instances, the video data sought for delivery is dropped, fragmented, delayed, or simply unavailable to certain end users.

Adaptive Streaming is a technique used in streaming multimedia over computer networks. While in the past, most video streaming technologies used either file download, progressive download, or custom streaming protocols, most of today's adaptive streaming technologies are based on hypertext transfer protocol (HTTP). These technologies are designed to work efficiently over large distributed HTTP networks such as the Internet.

HTTP-based Adaptive Streaming (HAS) operates by tracking end-to-end network bandwidth and the CPU and memory bandwidth of the HAS player, and then selecting an appropriate profile (e.g., bandwidth and resolution) among the available profiles (typically provided in a manifest file) to stream. Typically, HAS leverages the use of an encoder that can encode a single source video at multiple bit rates and resolutions (e.g., profile), which can be representative of either constant bit rate encoding (CBR) or variable bit rate encoding (VBR). The player client can switch among the different encodings depending on available resources. Ideally, the result of these activities is little buffering, fast start times, and good video quality experiences for both high-bandwidth and low-bandwidth connections.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for providing a scheduler based network virtual player in adaptive streaming environments in accordance with one embodiment of the present disclosure;

FIGS. 2-3 are simplified graphical illustrations depicting example adaptive streaming scenarios;

FIG. 4 is a simplified block diagram illustrating possible example details associated with one embodiment of the present disclosure; and

FIG. 5 is a simplified graphical illustration depicting example behavior associated with the network virtual player; and

FIG. 6 is a simplified block diagram illustrating possible example details associated with one embodiment of the present disclosure.

### DETAILED DESCRIPTION OF EXAMPLE EMBODIMENTS

### Overview

A method is provided in one example embodiment and includes identifying a bit rate associated with an adaptive streaming client (e.g., a hypertext transfer protocol (HTTP)-based Adaptive Streaming (HAS) client) that is engaged in a media session (which can include any suitable content, media, or data more generally). The bit rate is used to maintain a particular video quality for a media stream. The method also includes using a network virtual player to lock (e.g., set, designate, maintain, assign, secure, etc.) the bit rate for a particular time interval for the adaptive streaming client. The method also includes supporting the bit rate from a network for the adaptive streaming client during the media session. In more particular embodiments, the method can include detecting a plurality of congestion points through instrumentation of the underlying transmission control protocol (TCP) flows. A typical instrumentation, among other possible ones, could be monitoring duplicate acknowledgment (ACK) packets. For example, monitoring TCP ACK monitoring and reducing a committed service rate for the virtual player based, at least in part, on the monitoring.

In yet other instances, the method can include identifying a particular distance between two of the congestion points through an estimation of a current buffer depth and a previous service rate, where the bit rate is increased towards a level at which the particular distance between the two congestion points is within an acceptable limit. In addition, the network virtual player can include a set of priority queues, where at least one of the priority queues is to be depleted at a same bit rate of an actual player's decoding rate for the adaptive streaming client. A play out buffer of the network virtual player is to be filled at a same bit rate of a designated service rate of an actual player of the adaptive streaming client. A requested bit rate from a player of the adaptive streaming client under a steady state mode can reflect a queue depletion rate of the network virtual player.

Playback of the media stream results in the virtual network player entering into a buffering stage during which a step addition of bandwidth is allocated up to a maximum of available bandwidth. After buffering stage is complete, the virtual network player enters an on/off state and matches a service bit rate, as monitored from a particular queue with an exponential weighted moving average function.

In certain cases, domestic and include using one or more profiles to create a feedback loop that allows the network virtual player to speed up an initial adaptation to a particular profile after a pre-buffering phase. The network virtual player commits an initial bandwidth through an additive increase up to a high watermark when a designated service bit rate crosses a low watermark to facilitate an initial buffering stage. The network virtual player adapts to a required steady state service rate with an exponential moving average function to absorb at least one TCP burst or at least one transient.

### Example Embodiments

Turning to FIG. 1A, FIG. 1A is a simplified block diagram of a communication system 10 configured for offering a rate adaptation protocol using network virtual players for a plurality of HAS clients in accordance with one embodiment of the present disclosure. Communication system 10 may include a plurality of servers 12a-b, a media storage 14, a network 16, a transcoder 17, a plurality of hypertext transfer protocol (HTTP)-based Adaptive Streaming (HAS) clients 18a-c, and an intermediate node 15. Communication system 10 also includes a home router 25, which further includes a virtual network player 35, a processor 24, and a memory element 26. Home router 25 may be coupled to any number of intermediate nodes 15 over a bottleneck link 19, which may become systematically congested due to any number of traffic patterns. It should be noted that the terms ‘ABR player’ and ‘HAS client’ are used interchangeably in contexts discussed herein in this Specification.

Note that the originating video source may be a transcoder that takes a single encoded source and “transcodes” it into multiple rates, or it could be a “Primary” encoder that takes an original non-encoded video source and directly produces the multiple rates. Therefore, it should be understood that transcoder 17 is representative of any type of multi-rate encoder, transcoder, etc.

Servers 12a-b are configured to deliver requested content to HAS clients 18a-c. The content may include any suitable information and/or data that can propagate in the network (e.g., video, audio, media, any type of streaming information, etc.). Certain content may be stored in media storage 14, which can be located anywhere in the network. Media storage 14 may be a part of any Web server, logically connected to one of servers 12a-b, suitably accessed using network 16, etc. In general, communication system 10 can be configured to provide downloading and streaming capabilities associated with various data services. Communication system 10 can also offer the ability to manage content for mixed-media offerings, which may combine video, audio, games, applications, channels, and programs into digital media bundles.

In accordance with the teachings of the present disclosure, the framework disclosed herein addresses the management of priority ABR videos (over an access link) by designing a network based rate adaptation scheme that behaves like a virtual ABR playback engine. More specifically, network virtual player 35 can offer several important functions, including:
1. Running in a rate-locked control loop with the actual ABR player in steady state.
2. Minimizing the bandwidth wastage by releasing unused bandwidth as it adapts to the service rate of the actual player.
3. Absorbing the TCP bursts and network transients in favor of priority ABR stream.
4. Addressing the prioritization of LAN side devices for both access link contention and LAN side contention.

One part of the solution outlined herein defines a methodology where a network based adaptation scheme drives the actual ABR player in a consistent steady state mode, while handling network transients. While certain queue management techniques are prevalent in networks today, none exists inside home networks that can suitably handle both access link and local area network (LAN)-side contentions. Note that the rate adaptation techniques outlined herein can achieve an optimal bandwidth sharing regardless of the underlying transport protocol's behavior (e.g., TCP, SCTP, MP-TCP, etc.). In certain cases, the underlying transport protocol's behavior can matter in that the transport protocol can have a mechanism to detect hints of congestion and back off.

Before detailing these activities in more explicit terms, it is important to understand some of the bandwidth challenges encountered in a network that includes HAS clients. The following foundational information may be viewed as a basis from which the present disclosure may be properly explained. Adaptive streaming video systems make use of multi-rate video encoding and an elastic IP transport protocol suite (typically hypertext transfer protocol/transmission control protocol/Internet protocol (HTTP/TCP/IP), but could include other transports such as HTTP/SPDY/IP, etc.) to deliver high-quality streaming video to a multitude of simultaneous users under widely varying network conditions. These systems are typically employed for “over-the-top” video services, which accommodate varying quality of service over network paths.

The industry has seen a profound proliferation of “over-the-top” (OTT) video (e.g., most of which is internet-based). Concurrently, the deployment of ABR systems for playback purposes has grown exponentially. Note that the term OTT simply refers to the delivery of content or services over an infrastructure that is not under the administrative control of the content or service provider.

In adaptive streaming, the source video is encoded such that the same content is available for streaming at a number of different rates (this can be via either multi-rate coding, such as H.264 AVC, or layered coding, such as H.264 SVC). The video can be divided into “chunks” of one or more group-of-pictures (GOP) (e.g., typically two (2) to ten (10) seconds of length). HAS clients can access chunks stored on servers (or produced in near real-time for live streaming) using a Web paradigm (e.g., HTTP GET operations over a TCP/IP transport), and they depend on the reliability, congestion control, and flow control features of TCP/IP for data delivery. HAS clients can indirectly observe the performance of the fetch operations by monitoring the delivery rate and/or the fill level of their buffers and, further, either upshift to a higher encoding rate to obtain better quality when bandwidth is available, or downshift in order to avoid buffer underruns and the consequent video stalls when available bandwidth decreases, or stay at the same rate if available bandwidth does not change. Compared to inelastic systems such as classic cable TV or broadcast services, adaptive streaming systems use significantly larger amounts of buffering to absorb the effects of varying bandwidth from the network.

In a typical scenario, HAS clients would fetch content from a network server in segments. Each segment can contain a portion of a program, typically comprising a few seconds of program content. [Note that the term ‘segment’ and ‘chunk’ are used interchangeably in this disclosure.] For each portion of the program, there are different segments available with higher and with lower encoding bit rates: segments at the higher encoding rates require more storage and more transmission bandwidth than the segments at the lower encoding rates. HAS clients adapt to changing network conditions by selecting higher or lower encoding rates for each segment requested, requesting segments from the higher encoding rates when more network bandwidth is available (and/or the client buffer is close to full), and requesting segments from the lower encoding rates when less network bandwidth is available (and/or the client buffer is close to empty).

FIG. 2 is a simplified graphical illustration 40 that depicts example behavior associated with an ABR player during a high definition (HD) video playback. The buffering stage and the adaptive on/off stage are being shown in this particular example. In operation, an ABR system essentially works as a closed loop control system. Most ABR systems operate in two stages:
1. Buffering—During startup, the player tries to fill up the decoder buffer aggressively and works in a progressive download mode.
2. Post-Buffering—Once the buffer is filled up, the player moves into an on/off mode using a specific service rate profile. During this mode, the asking rate closely matches the decoding rate. Given above, the system looks like a second order system, where there is a step jump of asking rate, which gradually settles down with a steady state service rate.

One of the design motivations of ABR systems is to adapt to changes in the available best effort network bandwidth. Changes could happen for several reasons such as, for example, the contention being created by another ABR or non-ABR stream. Hence, a user assigned priority ABR video has been mapped to a corresponding priority treatment at the gateway devices, as the best effort packets enter the gateway at the edge of home.

There are a number of problems of prioritization at home access router. First, home access routers typically handle bandwidth prioritization through two mechanisms:
1. Priority marking packets such that wireless network segments can handle it through proper wireless multimedia access category scheduling.
2. Some level of intra-class prioritization through a static share of bandwidth allocations for priority streams. For example, OTT streams being predominantly best effort, a best effort ABR video can be prioritized over another best effort progressive video.

Both of the above mechanisms fail to solve the problem when the access link is the link of contention. In the case involving OTT video, that is typically the prominent issue with such deployments. Again, intra-class prioritization through static bandwidth allocation has an inherent problem of over-provisioning and, further, wasting bandwidth when a priority stream does not use all the allocated bandwidth. This is one of the major problems in the context of this discussion because ABR OTT videos tend to change the behavior of the player as it transits from one state to other. For example, a typical ABR stream starts in the buffering state and behaves like a progressive download stream. Once it fills up the buffer, it moves into an on/off state and settles down with a service rate that maps the required video profile.

Hence, OTT video enters the last mile including the access link as best effort video. Any network contention between multiple competing streams forces the ABR stream either to take a longer time in the buffering stage and to stay in adaptive mode with continuous on/off switching. This creates player oscillations, buffer underrun, switching between profiles, etc. The problem is sought to be solved through prioritization. However, the prioritization is not necessarily solving the issue based on the domain of contention.

It should also be noted that allocating required bandwidth for a TCP-based stream is difficult since the profile requirement is typically not known a-priori. Home routers handle this problem through a scheduler configured for borrowing between leaf queues under a root queue (e.g., Hierarchical Token Bucket (HTB), Hierarchical Fair Service Curve (HFSC), etc.), which allows non-priority streams to borrow bandwidth from priority streams when the priority stream is consuming lesser than the allocated bandwidth.

However, this method does not work when the access link is the link of contention between two competing streams since the access router sits at the downstream edge of the access link. In fact, under such a scenario the borrowing among queues essentially kills the prioritization and the TCP fairness preempts the application priority treatment; both the streams settle down sharing the access link bandwidth equally. In addition, this model relies heavily on an accurate measurement of total available bandwidth. Any major under provisioning will render bandwidth wastage. At the same time, any major over provisioning beyond the half of the available bandwidth will create TCP preemption to take control and offset the prioritization.

In essence, there are two main problems to solve while treating a priority ABR stream over access link:
1. Home routers should be able to able to offer the required service rate to the priority ABR streams during buffering and steady state playback periods.
2. Home routers should be able to release unused bandwidth to non-priority streams when ABR streams are running in steady state on/off mode.

An additional problem to be solved is the player oscillations and buffer underrun in the event of network transients, which is common. Any viable rate adaptation algorithm should generally yield a high average video quality, a low variation of video quality, and offer a low chance of video play out stall caused by buffer underruns.

In operation of a typical scenario involving a home network, a home access router would provide a static bandwidth allocation for priority streams. In order to avoid the bandwidth wastage and undue starvation of non-priority streams, a borrowing based-scheme is used. In this model, a lower priority stream borrows bandwidth from a higher priority stream as long as the higher priority stream is running below allocated rate. While this model works well for managing the contention domain on the downstream side of the access router, it does not work when the access link on the north side is the domain of contention. In such scenario, the TCP fairness preempts stream prioritization and both priority and non-priority streams start sharing the access link bandwidth equally. In addition, this model depends heavily on a static configuration of available bandwidth. However, the available bandwidth, especially the one over access link, changes over time and any over provisioning will render the prioritization useless for TCP preemption and any under provisioning will create bandwidth wastage.

Turning to FIG. 3, FIG. 3 is a simplified graphical illustration 45 that depicts ABR player behavior in certain scenarios. This particular graphical illustration shows how the player does not get a chance to buffer enough, as it is systematically adaptive sharing half of the available bandwidth with an unclassified stream. In addition, a buffering delay is caused for an inadequate initial service rate. During the on/off stage of adaptive bit rate, one additional unclassified stream can force the player to buffer underrun.

FIG. 4 is a simplified block diagram illustrating one possible implementation associated with the present disclosure. In a particular embodiment, network virtual player 35 may include a controller 55 and a scheduler 57, which may include a plurality of priority queues 60. Controller 55 may include a low watermark (LWM) and a high watermark (HWM). This particular framework of FIG. 4 also includes a committed rate 80, a current rate 85, and a service rate that is being provided to an ABR player 65. Before detailing the activities of network virtual player 35, is important to appreciate some of the objectives associated with prioritization.

There are two goals for solving the problems of prioritization:
1. Home routers should be able to offer the required service rate to the ABR player during the buffering and steady state on/off states.
2. Home routers should release the bandwidth unused by the ABR player during on/off steady state to the non-priority streams.

The above goal can be achieved through the design of scheduler 57, which works as a closed loop feedback control system. The system takes the current measured rate as at least one of the inputs and the output is a committed bit rate that starts with a step increase and then adapts to the steady state service rate of network virtual player 35. As the committed rate is slowly decreased to match the service curve of the priority stream asymptotically, the non-priority streams start borrowing the released committed rate. In an analogy to an ABR system, scheduler 57 works at the network level as a virtual ABR player that closely matches the behavior of the actual ABR player. It is not actually required to know the range of bit rates available for a particular video playback. However, if that information is available then the adaptation curve can be more aggressively adjusted.

In one particular example, the adaptive bit rate network virtual player is built using a set of standard priority queues. A queue can be deemed as a virtual play out buffer. The queue is required to be depleted at the same rate of the actual player's decoding rate. In addition, the play out buffer should be filled at the same rate of the required service rate of the actual player. However, the only difference between the actual play out buffer and the virtual play out buffer is that there is no actual buffering required for the virtual play out buffer.

It is important to note that ABR players work in their own close loop control system. The player selects the video segment from a particular profile based on available network bandwidth (measured in units of time based on download time for a particular time), CPU bandwidth, buffer depletion rate, buffer depth etc. Hence, the asking rate from the player under steady state on/off mode is actually the queue depletion rate of the network virtual player. In one general sense, there is no actual TCP window on the network virtual player. Instead, the Round Trip Time (RTT) should be maintained. The network virtual player will monitor the service rate from the queue and will try to adapt to that service rate over time. The player will also synchronize with the actual player's state. When a playback starts, the virtual player will enter a buffering stage during which a step addition of bandwidth is allocated up to a maximum of available bandwidth. Once the buffering is complete, the player enters the on/off state and the virtual player starts to slowly match the service rate as monitored from the queue with an exponential weighted moving average function. Therefore, in one generic sense, this virtual player acts as Additive Increase Exponential Decrease (AIED).

In operation, the exponential decay is made more conservative through a low pass filter, where more weight is given to the previous rate sample. A typical mathematical representation of that exponential decrease over time can be represented as:

R_{c}(t)=α^{t-1}_{*}R_{c}(0)+(1−α)[R(t)+α_{*}R(t−1)+α²_{*}R(t−2)+α³_{*}R(t−3)+ . . . ] where α<1

The additive increase is to create enough headroom for the player to quickly fill up the buffer, especially in buffering stage or during on/off stage when the real player makes an up shift because the available access link capacity at a certain time increases. This, however, can also be thought of as allowing the TCP window to grow but the increment is not necessarily required to match the next TCP window worth of bytes. However, in a certain implementation it could do so, as long as the next window worth of bytes can be tracked. It is simply an implementation choice. The time scale also depends on the implementation. In one example implementation, it was some degree of milliseconds since the HTB queues in Linux reports the current rate over a smoothed interval of four samples with milliseconds of time ticks. The Al during the buffering period is a step increase with an addition of bandwidth that is equal to the high water mark value. Thereafter, the Al is the difference between the current measured rate and the high water mark. After the initial step increase, the AIED is maintained within two asymptotes (e.g., low water mark and high water mark).

In addition to the above basic rate adaptation function, the player can be enhanced with additional feedback control systems. OTT ABR players generally run on top of TCP. Hence, network oscillations can move the player out of steady state easily. In order to continuously run the player in steady state, the network virtual player can incorporate a congestion point detection mechanism. The goal is to minimize the distance between congestion points through a correlation function against a target congestion point distribution function.

Congestion points can be detected for competing streams through flow instrumentations. One such instrumentation could be to monitor TCP ACKs, as every third duplicate ACK can be an indication of congestion. In general, the idea is to use a target probability distribution function (PDF) of distance between congestion points over a time scale and correlate it with the actual distribution of congestion points detected over a certain time period. The exponential rate adjustments can be done until achieving the target PDF. Therefore, two feedback loops can be used to better provision the network virtual player rate allocation; one for the current rate and another for the time distribution of congestion points.

Yet another feedback loop is attached to the network virtual player, where the a-priori knowledge of ABR profiles are available. This knowledge allows the virtual player to speed up the initial adaptation to a particular profile after the pre-buffer phase. Once it adapts to the profile rate, it then slows down in adaptation to match the actual service rate. This, in turn, allows the network virtual player to run in Additive Increase Multiplicative Decrease (AIMD) followed by Additive Increase Exponential Decrease (AIED). This helps non-priority streams to borrow bandwidth quickly during the initial adaptation phase.

FIG. 5 is a simplified graphical illustration 75 depicting certain behavior associated with a network virtual player. In this example, the network virtual player commits an initial bandwidth through an additive increase up to the high watermark when the service rate crosses the low watermark to facilitate an initial buffering stage. The network virtual player adapts to a required steady state service rate slowly with an exponential moving average function so as to absorb TCP bursts and transients. A non-priority (unclassified) competing stream starts with a minimum threshold and start borrowing from the priority ABR stream, as the network virtual player adapts to the steady state service rate of the actual player.

Transients, either short term or long term, are common over an access link. For example, a cable network in a crowded neighborhood can experience a sudden drop in the access link throughput (typically, in the evening when most of the people in the neighborhood starts watching a particular event). The same scenario could present itself when individuals watch HD video (e.g., YouTube content). Such network transients create closely distributed congestion points that drive the ABR player out of steady state and that exhibits an oscillatory behavior. In order to avoid this oscillation in the player, the following measurements are done and fed back to the virtual player to adjust the service rate to the player.

1. Detect congestion points and measure the inter-congestion point distance.

2. When there is congestion, then the service rate to non-priority traffic is reduced until the distance between congestion points of the priority traffic is almost zero. As network congestion (with respect to priority traffic) becomes acceptable, and then the service rate to non-priority traffic is slowly increased.

3. A reverse mapping, where the actual player closely matches the service rate of the virtual player (avoiding oscillations).

Without the knowledge of range of bit rate profiles of the ABR stream, the adaptation to the steady state behavior of ABR should be made slowly. Hence, a low pass filter (e.g., with a value of alpha as 0.95) is typically used. This effectively slows down the bandwidth borrowing mechanism for non-priority streams. If the range of profiles are known then an initial adjustment borrowing can be done with a step decrease from one profile to another. Finally, a steady state behavior can be achieved within the boundary of two profiles. A low pass filter with high alpha value can be used within these two ranges to slowly converge to the required service rate. Hence, another feedback loop can be added to the system with the set of profiles as selected by the ABR player for a certain playback. This essentially creates the adaptation in two steps. The first step is a faster adaptation through AIMD (Additive Increase and Multiplicative Decrease) followed by a slower adaptation through AIED (Additive Increase and Exponential Decrease).

FIG. 6 is a simplified block diagram illustrating one implementation of an advanced network virtual player. In this particular example, a target distribution of congestion points is provided to controller 55, along with a plurality of ABR profiles. In this example, the committed rate adapts to the ABR service rate. Rates are committed within the low watermark and the high watermark limits. The rate adaptation can operate as discussed above, where the reverse adaptation through avoidance of high-density congestion points is also executed. The ABR profile awareness speeds up the rate adaptation (e.g., through AIMD rather than AIED).

In one example implementation, the adaptive bit rate network virtual player is done on top of a scheduler using priority queues with a controlled Token Bucket Filter (TBF) functions. The controlled TBF can be a modified Hierarchical Token Bucket (HTB) or Hierarchical Fair Service Curve (HFSC) with the Rate Adapter module configuring the ceiling rates, assured rates, and optionally configuring the latency figure. This operates as an Active Queue Management system. On a typical home access router, this queue discipline is added to a bridge interface that ties up LAN side network interfaces. All WAN-to-LAN forward and reverse traffic can be passed through this bridging interface. This essentially ensures that LAN devices, regardless of which physical interface being used, are controlled by the same network virtual player. It is to be noted that multiple real ABR players can be served up by one network virtual player. This is typically the case when multiple ABR players are prioritized with equal importance and share the same committed service rate.

The deployment of the network virtual player is an implementation choice. The network virtual player can include two parts—configuration and instrumentation. The algorithm that drives the configuration can reside inside the home router, in the cloud, or in any other appropriate location in the network. The instrumentation can be performed on actual priority queues (PRIO+TBF) that runs on routers and, further, feeds back the rate information to the configuration module for proper provisioning of allocation of bandwidth. It does not need to depend on control planes since the measurement is done on egress queues (PRIO+TBF) in the kernel or device drivers. There is typically no need to sniff at the control plane. In a particular example, the design of the network virtual player tries to avoid the dependency on the stream control plane and handles it through gradual rate lock mechanisms over a feedback control loop within two dynamic asymptotes; one is the maximum bandwidth and another is the current download rate plus some headroom.

In one example implementation of the network virtual player, and in terms of a PRIO TBF framework, the number of available tokens is a degree higher than the required tokens. This makes a virtual representation of the play out buffer, where the depletion rate can be equal to the filling rate as long as there are outstanding packets in the queue. The step increase of allocated bandwidth during the pre-buffering stage and the smooth and slow exponential decrease or allocated bandwidth during on/off stage keeps the buffer provisioned for enough headroom. However, the only buffering that might happen is at the egress queues when the egress link speed is slower than ingress link. For example, the wireless link could be somewhat slower, in some cases, than the WAN link (it is highly unlikely for most of the video ecosystem deployments though). In such cases, the real player will slow down itself and, in turn, slow down the ingress rate. The network virtual player provisioning can match that as well. The idea is to generally maintain the same buffer depth and filling rate at the actual player's play out buffer.

Typically, the home network will be physically or logically separated into a managed domain and an unmanaged domain. A service provider could deliver service in the managed domain and the consumer's other devices can reside in unmanaged domain. The network virtual player can be configured for the devices in unmanaged domain. This means if the competition were between two unmanaged devices, then the network virtual player would be enforced. If the competition were between a managed and an unmanaged device then the network virtual player would not be used. In terms of implementation, a hierarchical token bucket mechanism can be useful in this case.

In operation of an example scenario, the real player tries to download the fragments during on/off stage at a rate that accounts for the current profile plus the bandwidth margin. Therefore, exponentially matching the allocated rate to the current download rate (e.g., asymptotically) over time will account for the additional margin. As an alternative, however, the knowledge of available profiles can be used as well. The allocated rate could be matched to the profile rate that is immediately higher than the current download rate. Furthermore, additional logic could be added to trigger an additive increase when a downshift is encountered. The downshift is the action that the player will take to avoid the buffer underrun. The goal of this network virtual player is to avoid this downshift and maintain the current buffer fill rate.

Note that the network virtual player function does not depend on the actual fragment types (e.g., constant bit rate (CBR) or variable bit rate (VBR) fragments). It predominantly measures the current fragment download rate and simply tries to maintain that rate in order to maintain the current profile in steady state.

It should also be noted that some level of deep packet inspection (DPI) may be used to identify the state of the ABR stream. For example, the HTTP URL can be inspected for .isma or .ismv extensions to know that it is a smooth streaming video session. The profiles are typically payload data and they can spawn more inspection into the XML like schema based on the streaming type and specification. However, if the profile is encrypted then it might not be possible to know the profiles unless either the actual player or the backend server relays the profiles. However, the design of the network virtual player can avoid these complications and use a feedback control loop to maintain a particular profile rate as chosen by the real player.

Turning to the example infrastructure associated with the present disclosure, HAS clients 18a-c can be associated with devices, customers, or end users wishing to receive data or content in communication system 10 via some network. The terms ‘adaptive streaming client’, ‘HAS client’, and ‘client’ more generally is inclusive of devices used to initiate a communication, such as any type of receiver, a computer, a set-top box, an Internet radio device (IRD), a cell phone, a smart phone, a tablet, a personal digital assistant (PDA), a Google Android™, an IPhone™, an IPad™, or any other device, component, element, endpoint, or object capable of initiating voice, audio, video, media, or data exchanges within communication system 10. HAS clients 18a-c may also be inclusive of a suitable interface to the human user, such as a display, a keyboard, a touchpad, a remote control, or any other terminal equipment. HAS clients 18a-c may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

Transcoder 17 (or a multi-bit rate encoder) is a network element configured for performing one or more encoding operations. For example, transcoder 17 can be configured to perform direct digital-to-digital data conversion of one encoding to another (e.g., such as for movie data files or audio files). This is typically done in cases where a target device (or workflow) does not support the format, or has a limited storage capacity that requires a reduced file size. In other cases, transcoder 17 is configured to convert incompatible or obsolete data to a better-supported or more modern format.

Network 16 represents a series of points or nodes of interconnected communication paths for receiving and transmitting packets of information that propagate through communication system 10. Network 16 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber-to-the-x (FTTx), which is a generic term for any broadband network architecture that uses optical fiber in last-mile architectures, and data over cable service interface specification (DOCSIS) cable television (CATV). The architecture can also operate in junction with any 3G/4G/LTE cellular wireless and WiFi/WiMAX environments. The architecture of the present disclosure may include a configuration capable of transmission control protocol/internet protocol (TCP/IP) communications for the transmission and/or reception of packets in a network.

In more general terms, HAS clients 18a-c, transcoder 17, home router 25, and servers 12a-b are network elements that can facilitate the rate adaptation activities discussed herein. As used herein in this Specification, the term ‘network element’ is meant to encompass any of the aforementioned elements, as well as routers, switches, cable boxes, set-top boxes of any kind, gateways, bridges, load balancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, virtual network player 35 includes software to achieve (or to foster) the rate adaptation activities discussed herein. This could include the implementation of instances of virtual network player 35 at various locations in the network (e.g., in the home router, in the cloud, in the client, etc.). Additionally, each of these elements can have an internal structure (e.g., a processor, a memory element, etc.) to facilitate some of the operations described herein. In other embodiments, these rate adaptation activities may be executed externally to these elements, or included in some other network element to achieve the intended functionality. Alternatively, HAS clients 18a-c, transcoder 17, and servers 12a-b may include software (or reciprocating software) that can coordinate with other network elements in order to achieve the rate adaptation activities described herein. In still other embodiments, one or several devices may include any suitable algorithms, hardware, software, components, modules, interfaces, or objects that facilitate the operations thereof.

In certain alternative embodiments, the rate adaptation techniques of the present disclosure can be incorporated into a proxy server, web proxy, cache, content delivery network (CDN), etc. This could involve, for example, simple messaging or signaling can be exchanged between an HAS client and these elements in order to carry out the activities discussed herein. In this sense, some of the rate adaptation operations can be shared amongst these devices.

In operation, such a CDN can be provisioned with a virtual network player to offer bandwidth-efficient delivery of content to HAS clients 18a-c or other endpoints, including set-top boxes, personal computers, game consoles, smartphones, tablet devices, iPads, iPhones, Google Droids, customer premises equipment, or any other suitable endpoint. Note that servers 12a-b (previously identified in FIG. 1A) may also be integrated with or coupled to an edge cache, gateway, CDN, or any other network element. In certain embodiments, servers 12a-b may be integrated with customer premises equipment (CPE), such as a residential gateway (RG). Content chunks may also be cached on an upstream server or cached closer to the edge of the CDN. For example, an origin server may be primed with content chunks, and a residential gateway may also fetch and cache the content chunks.

As identified previously, virtual network player 35 can include software to achieve the rate adaptation operations, as outlined herein in this document. In certain example implementations, the rate adaptation functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [memory 26 shown in FIG. 1A] can store data used for the operations described herein. This includes the memory element being able to store instructions (e.g., software, code, etc.) that are executed to carry out the activities described in this Specification. The processor (e.g., processor 24) can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the rate adaptation activities, as outlined herein. Additionally, each of these devices may include a processor that can execute software or an algorithm to perform the rate adaptation activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that while the preceding descriptions have addressed segment sizes employed in systems like Microsoft Smooth Streaming, the present disclosure could equally be applicable to other technologies. For example, Dynamic Adaptive Streaming over HTTP (DASH) is a multimedia streaming technology that could benefit from the techniques of the present disclosure. DASH is an adaptive streaming technology, where a multimedia file is partitioned into one or more segments and delivered to a client using HTTP. A media presentation description (MPD) can be used to describe segment information (e.g., timing, URL, media characteristics such as video resolution and bit rates). Segments can contain any media data and could be rather large. DASH is codec agnostic. One or more representations (i.e., versions at different resolutions or bit rates) of multimedia files are typically available, and selection can be made based on network conditions, device capabilities, and user preferences to effectively enable adaptive streaming. In these cases, communication system 10 could perform rate adaptation based on the individual client needs.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its techniques) are readily scalable and, further, can accommodate a large number of components, as well as more complicated/sophisticated arrangements and configurations. Accordingly, the examples provided should not limit the scope or inhibit the broad techniques of communication system 10, as potentially applied to a myriad of other architectures.

It is also important to note that the steps in the preceding FIGURES illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure. In addition, the present disclosure can apply to any type of congestion monitoring (e.g., applying to any kind of ACK/NAK/Retransmissions).

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
identifying a bit rate associated with an adaptive streaming client that is engaged in a media session, wherein the bit rate is used to maintain a particular video quality for a media stream;
using a network virtual player to lock the bit rate for a particular time interval for the adaptive streaming client; and
supporting the bit rate from a network for the adaptive streaming client during the media session.

2. The method of claim 1, further comprising:
detecting a plurality of congestion points through flow instrumentation; and
reducing a committed service rate for the virtual player based, at least in part, on the flow instrumentation.

3. The method of claim 2, further comprising:
identifying a particular distance between two of the congestion points through an estimation of a current buffer depth and a previous service rate, wherein the bit rate is increased towards a level at which the particular distance between the two congestion points is within an acceptable limit.

4. The method of claim 1, wherein the network virtual player includes a set of priority queues, and wherein at least one of the priority queues is to be depleted at a same bit rate of an actual player's decoding rate for the adaptive streaming client.

5. The method of claim 1, wherein a play out buffer of the network virtual player is to be filled at a same bit rate of a designated service rate of an actual player of the adaptive streaming client.

6. The method of claim 1, wherein a requested bit rate from a player of the adaptive streaming client under a steady state mode reflects a queue depletion rate of the network virtual player.

7. The method of claim 1, wherein the network virtual player is to maintain one or more TCP window worth of bytes to provide at least a same bit rate as a service rate seen by a particular queue.

8. The method of claim 1, wherein playback of the media stream results in the virtual network player entering into a buffering stage during which a step addition of bandwidth is allocated up to a maximum of available bandwidth.

9. The method of claim 1, wherein after a buffering stage is complete, the virtual network player enters an on/off state and matches a service bit rate, as monitored from a particular queue with an exponential weighted moving average function.

10. The method of claim 1, further comprising:
using one or more profiles to create a feedback loop that allows the network virtual player to speed up an initial adaptation to a particular profile after a pre-buffering phase.

11. The method of claim 1, wherein the network virtual player commits an initial bandwidth through an additive increase up to a high watermark when a designated service bit rate crosses a low watermark to facilitate an initial buffering stage.

12. The method of claim 1, wherein the network virtual player adapts to a required steady state service rate with an exponential moving average function to absorb at least one TCP burst or at least one transient.

13. The method of claim 1, wherein the network virtual player is provisioned on top of a scheduler using a plurality of priority queues with at least one controlled Token Bucket Filter (TBF) function.

14. The method of claim 13, wherein the controlled TBF is a modified Hierarchical Token Bucket (HTB) or a Hierarchical Fair Service Curve (HFSC).

15. The method of claim 1, further comprising:
using a low pass filter to converge to a required service rate for the adaptive streaming client.

16. The method of claim 1, wherein the virtual network player is provisioned in a home router that interfaces with a plurality of adaptive streaming clients.

17. One or more non-transitory tangible media that includes code for execution and when executed by a processor operable to perform operations comprising:
identifying a bit rate associated with an adaptive streaming client that is engaged in a media session, wherein the bit rate is used to maintain a particular video quality for a media stream;
using a network virtual player to lock the bit rate for a particular time interval for the adaptive streaming client; and
supporting the bit rate from a network for the adaptive streaming client during the media session.

18. The media of claim 17, the operations further comprising:
detecting a plurality of congestion points through flow instrumentation; and
reducing a committed service rate for the virtual player based, at least in part, on the flow instrumentation.

19. The media of claim 18, the operations further comprising:
identifying a particular distance between two of the congestion points through an estimation of a current buffer depth and a previous service rate, wherein the bit rate is increased towards a level at which the particular distance between the two congestion points is within an acceptable limit.

20. A network element, comprising:
a processor;
a memory; and
a network virtual player, wherein the network element is configured to:
identify a bit rate associated with an adaptive streaming client that is engaged in a media session, wherein the bit rate is used to maintain a particular video quality for a media stream;
use a network virtual player to lock the bit rate for a particular time interval for the adaptive streaming client; and
support the bit rate from a network for the adaptive streaming client during the media session.

21. The network element of claim 20, wherein the network element at a home router configured to interface with a plurality of adaptive streaming clients.
